(19) United States
(12) Patent Application Publication
(10) Pub. No.: US 2025/0362736 A1
(43) Pub. Date: Nov. 27, 2025

(54) SYSTEM AND METHOD FOR ON-BODY TOUCH INPUT USING HEAD-MOUNTED IMAGE SENSOR

(71) Applicant: Carnegie Mellon University, Pittsburgh, PA (US)

(72) Inventors: Vimal Mollyn, Pittsburgh, PA (US); Christopher Harrison, Pittsburgh, PA (US)

(73) Assignee: Carnegie Mellon University, Pittsburgh, PA (US)

(21) Appl. No.: 19/216,607

(22) Filed: May 22, 2025

Related U.S. Application Data
(60) Provisional application No. 63/650,627, filed on May 22, 2024.

(51) Int. Cl. G06F 3/01; G02B 27/01; G06V 40/10

(52) U.S. Cl. CPC G06F 3/011; G02B 27/0172; G02B 27/0179; G06V 40/107; G02B 2027/0138; G02B 2027/0178

(57) ABSTRACT

A system and method provide touch input for electronic devices and utilize and image sensor to detect contact between a finger and an appendage of a user, denoting a touch. Identification of a touch event is based on a change in appearance of the user's skin at the location of contact. The image sensor can be worn on or near the head of the user. Further, the system and image sensor can be incorporated into a device such as an AR/VR headset or smart glasses. No further instrumentation of the user is required to detect touch and the system and method are capable of performing in a range of lighting conditions across varied user skin tones.

### CROSS-REFERENCE TO RELATED APPLICATIONS

This application claims the benefit under 35 U.S.C. § 119 of U.S. Provisional Application Ser. No. 63/650,627, filed on May 22, 2024, which is incorporated herein by reference.

### STATEMENT REGARDING FEDERALLY SPONSORED RESEARCH

Not applicable.

### BACKGROUND OF THE INVENTION

The present disclosure generally relates to human-centered computing. More specifically, the disclosure relates to a system and method of computer interaction utilizing a user's hands and arms as a tactile surface for touch input.

In augmented and virtual reality (AR/VR) experiences, a user's appendages can serve as convenient and tactile input surfaces, which have been shown to be faster, more precise, and more comfortable than in-air input. The lack of tactility in today's in-air, or “floating”, AR/VR interfaces is perhaps best exemplified by the large virtual keyboards in current headsets. Despite their large size, interacting on these keyboards is notably worse than even a diminutive smart-phone keyboard. Bringing practical and robust on-skin touch tracking to AR/VR headsets can retain the convenience and flexibility of operating in a bare-hands manner, as opposed to controllers, while simultaneously offering rich and useful haptics, including proprioceptive cues, to further aid performance.

For these reasons, prior works have implemented technical approaches to enable on-body input. Unfortunately, few technologies meet three pillars appropriate for widespread adoption by users, including: no user instrumentation (i.e., a user wears only the headset with no other accessories); works across users/sessions/environments with no calibration; and real-time implementation that runs on mobile hardware. For example, several prior systems instrument the user's inputting arm. One prior system instrumented the user's hand by attaching an inertial measurement unit to the top of the user's fingernail. Another system utilized a combination of infrared sensors, inertial measurement units, and a camera to detect touch locations on the body. Another system used capacitive tape wrapped around the user's thumb to detect taps. Other approaches involved instrumenting the input-receiving arm. One simple system wrapped a flexible touchscreen around a user's arm. Another used capacitive touch sensors that could be applied to the user's skin. And yet another used a custom armband to detect bio-acoustic signals generated from the user's movements. Other system instrument both the receiving and inputting arms.

In addition to instrumenting the user's hands and/or arms, prior systems have attempted to detect touches using cameras placed in the environment around the user, such as a shoulder-worn depth camera, a forearm-worn camera, or a ceiling-mounted depth and infrared camera. Most of these camera-based systems relied on depth cameras, which are still less common in modern AR/VR headsets and lack accuracy when distinguishing between a hovering finger and a touching finger. Others attempted to use red/green/blue (RGB) cameras, but often illuminated the touch surface with light emitting diodes or did not use skin as a touch surface. Further, many of these camera-based systems suffered from poor accuracy when used with varying lighting conditions and when the user is moving.

Therefore, it would be advantageous to develop touch input that provides tactile feedback, accuracy, and robustness across diverse lighting conditions and skin tones, while utilizing an image device mounted near the user's head, as is typical when wearing AR/VR headsets.

### BRIEF SUMMARY

According to embodiments of the present disclosure is a system and method for on-body touch input using the image sensor of a body-worn device, such as an augmented and virtual reality headset or smart glasses. The system demonstrates high accuracy, bare hands (i.e., no special instrumentation of the user) skin input. Touch events are identified by the system using the image sensor and detecting a change in appearance of the surface of the user's skin where the touch occurred. The change in appearance can result from deformation (i.e. depression in otherwise flat surface) or color (i.e. shadowing or skin color change). The system is accurate and robust across diverse lighting conditions, skin tones, and body motion (e.g., input while walking). Finally, the system provides rich input metadata including touch force, finger identification, angle of attack, and rotation. The system provides technical features desired to more fully unlock on-skin interfaces that have been well motivated in the human/computer interaction field but have lacked robust and practical methods.

### BRIEF DESCRIPTION OF THE SEVERAL VIEWS OF THE DRAWINGS

FIG. 1 depicts the system according to one embodiment.

FIG. 2 shows the on-body touch input, with a field-of-view of an image sensor shown.

FIGS. 3A-3B compares hover versus touch on a user's arm.

FIG. 4 depicts the steps of the method according to one embodiment.

FIG. 5 is a graph showing accuracy for different skin tones and hair density.

FIG. 6 is a graph showing accuracy at different touch locations.

FIGS. 7A-7B are graphs showing accuracy and error for touches with different fingers.

### DETAILED DESCRIPTION

According to embodiments of the disclosure is a system 100 comprising an image sensor 101 that can be worn on or near the user's head 123. In one embodiment, the system 100 is incorporated into an augmented reality/virtual reality (AR/VR) headset 150, which contains an array of red/green/blue cameras 101 that are composited together to provide high-resolution passthrough, hand tracking, and other interactive features. FIG. 1 shows the system 100 worn by a user, with virtual icons that can be viewed by the user through the AR/VR headset 150. When a user presses on their hand, arm, or other body part 122 with a finger 121, the system 100 recognizes the ‘touch’ by recognizing a change in appearance of the user's skin near the touch location.

The system 100 recognizes the touch by analyzing the physical change in the surface of the skin and the color change. For example, when a user touches their index finger 121 to their forearm 122, the skin under the finger 121 will become deformed, creating a small crater or depression on the skin's surface. In addition, the touching of the user's finger 121 to their skin results in color changes do to localized shadows or blood flow changes, which temporarily changes the color of the user's skin.

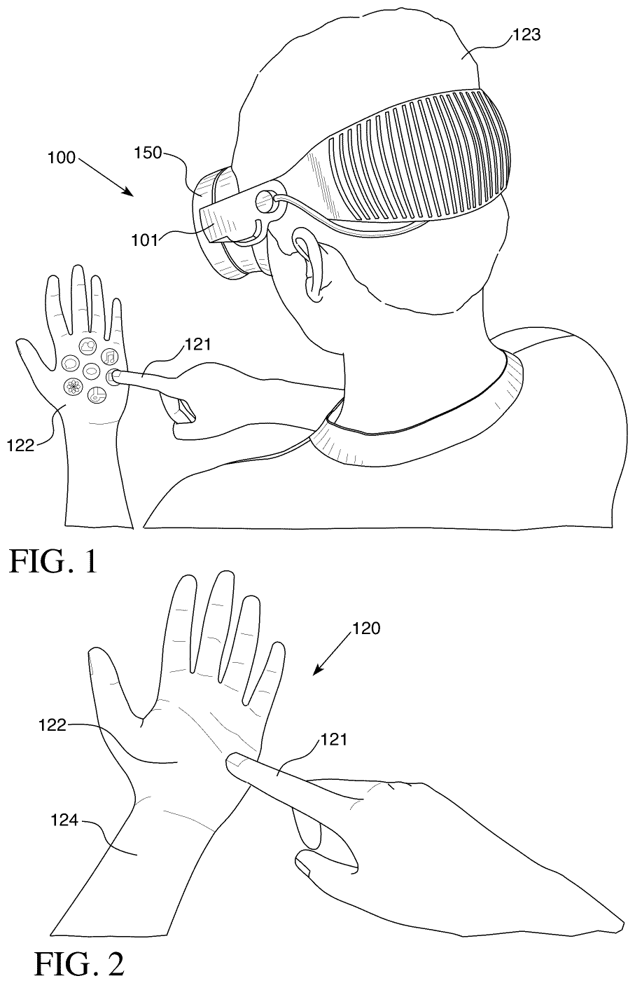

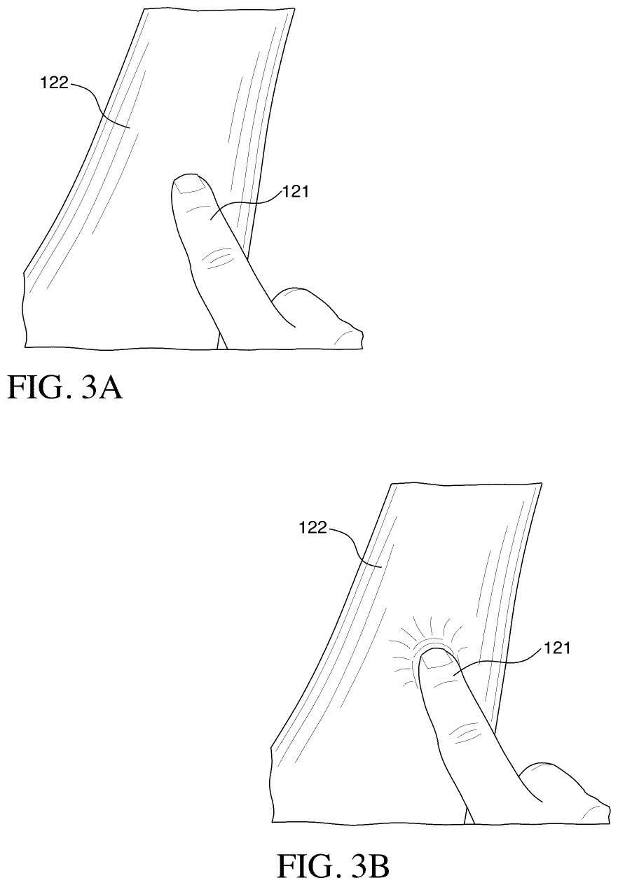

The image sensor 101 can be any imaging device that senses light, such as red/green/blue, infrared, and ultraviolet sensors 101, for example. FIG. 2 shows the field-of-view 120 of the image sensor 101 during a touch event, where the depression in the skin and the resulting color change are visible in the field-of-view 120. FIGS. 3A-3B highlight the difference between a hovering finger 121 (FIG. 3A), where the finger 121 is close but not touching, and a finger 121 touching an appendage 122 (FIG. 3B). As shown in FIGS. 3A-3B, the visual appearance of the user's skin is different between a hover and a touch event, which can be recognized and identified by the system 100.

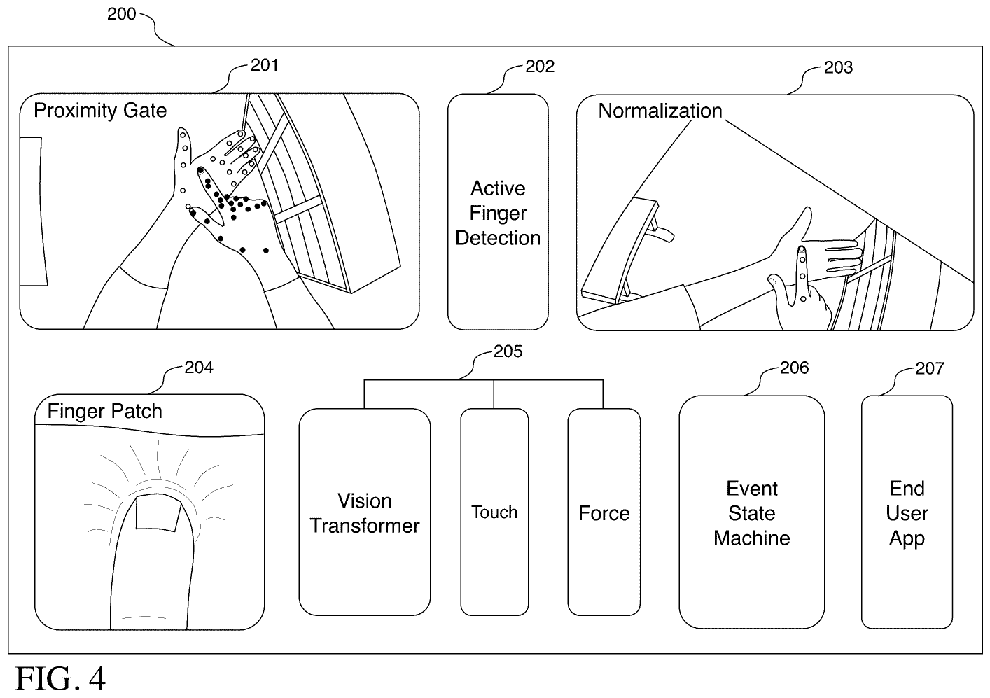

FIG. 4 is a flowchart of the steps of detecting a touch event, according to one embodiment of the method 200. The method comprises some or all of the following steps; running a proximity gate 201, detecting an active finger 202, normalizing image data 203, constructing a finger patch 204, running a vision transformer 205, inputting data into an event state machine 206, and providing results to an end user application 207. The method 200 can be executed by the system 100, which may include software, hardware, and a combination thereof to execute the various steps of the method 200. When the system 100 is integrated into a headset 150, many of the steps of the method 200 can be performed in real-time without the need to send data or perform computations on external hardware.

During the proximity gate 201 step, hand keypoints are extracted from data provided by the image sensor 101, which has a field-of-view 120 that may include at least one appendage 122 of the user. Given that that image sensor 101 is mounted on the head 123 or near the head 123 of the user, such as on the user's shoulder, chest or neck, the field-of-view 120 typically includes an area in front of the user's torso. In one embodiment, running the proximity gate 201 detects whether two hands or arms, or appendages 122, are present in front of the user, as a finger 121 and a second body part 122 are necessary for touch input by the user. That is, the proximity gate 201 determines if a touching finger 121 and a touch receiving appendage 122 are present in the field-of-view 120.

This task 201 can be accomplished with software known in the art, such as Google's MediaPipe Hand model, which is software capable of detecting and tracking hands in images or videos. In an example embodiment utilizing this model, hand bounding boxes are detected and, for present hands, 21 three-dimensional keypoints are labeled. Additionally, when running the proximity gate 201, the system 100 can perform a check to determine if the two appendages 122 are close enough for an on-body touch interaction. For example, the proximity gate 201 will identify proximity if a hand is within 3 palm lengths from the other hand or arm, which could indicate that the user is in a position to make a touch input.

FIG. 2 shows a field-of-view of where two hands 122 are present in the frame, meaning the proximity gate would return a positive finding, permitting the method 200 to proceed to the next step. If proximity is determined, a second check may be performed to determine if any fingers 121 are pointed outwards. Specifically, during active finger detection 202, the system 100 checks for fingers that might be indented or positioned for input. Stated differently, the system 100 checks if there are any fingers 121 pointing away from the wrist 124 and not tucked, as denoted by a wrist keypoint identified by the proximity gate. Any identified active fingers 121 permits the method 200 to pass to the next step, normalization 203.

During normalization 203, the system 100 rotates and scales the image provided by the image sensor 101 for each potentially active finger 121. For example, for each finger found, the image provided by the image sensor 101 is rotated to be finger-up aligned using the 3D joint data, providing a uniform orientation. While finger-up alignment is discussed in this example, any uniform orientation may be used. The image is also scaled based on the distance between the distal interphalangeal (DIP) and fingertip joints of the finger 121, or other suitable keypoints. This sub-process helps to normalize the input image across users' different sized hands and across different operational distances. Example output from this process is shown in FIG. 4 (top right), where the touching finger 121 is rotated from the original image.

From this normalized image, a finger patch (i.e. area around the fingertip) is extracted 204 from the image data. The system 100 takes a roughly 4×4 cm patch, or area of the image, (with a resolution of 100×100 px) centered at the fingertip. The size and resolution of the finger patch may vary depending on the intended application or lighting conditions, among other factors. Normalization 203 and finger patch extraction 204 can be performed for each active finger 121, allowing for multi-touch tracking. The output, or finger patches, is transferred in parallel to the touch and force model.

At step 205, the touch and force model takes the image data representing the finger patches as input and outputs a touch prediction and press force estimate. This is done for all active fingers 121 in parallel. In one example embodiment, the model is a hybrid vision transformer model built on top of the FastViT T8 backbone. The model can perform image classification, detection, segmentation, and 3D mesh regression. Further, this model encodes the image patches (in parallel if multiple) and produces image embeddings which are linearly transformed to embeddings of dimension 126. This is then concatenated with the R and θ polar coordinates of the right fingertip relative to the left wrist (for right-handed input; would be swapped for left-handed input), on the axis formed between the wrist and the base (MCP) of the middle finger, forming a frame embedding of size 128. These embeddings are ReLU (rectified linear unit) activated and linearly transformed into touch classification logits and force outputs. To suppress single-frame errant output, the system 100 can apply a three-frame median filter to both the touch and force outputs. The model in this example embodiment has 4.1 million trainable parameters. After training, the system 100 can structurally reparameterize the model to a mathematically equivalent model with fewer branches and parameters. In one embodiment, the final model has 3.8 million parameters for inference.

The model used in step 205 can be trained during a user study. Here, the system 100 employs a leave-one-participant-out cross-validation scheme to train and test the models (i.e., a participant's data never appears in their training data and there is no calibration data or equivalent). In one embodiment, the models were developed and trained using the PyTorch and PyTorch Lightning deep learning frameworks. The FastViT backbone is initialized with pre-trained ImageNet weights. For touch prediction, the system 100 computes a weighted binary cross-entropy loss, weighted by the ratio of touch and non-touch frames in the batch. For press force prediction, the system 100 computes a mean-squared error (MSE) loss and regress to the ground truth. The total loss of the model is a weighted sum of the touch and force losses (touch loss=1×, force loss=5×). The model is trained end-to-end for eight epochs using the Adam optimizer, batch size of 128, and a learning rate of 0.0003. In this example embodiment, the models train in about four hours on an Nvidia Titan V GPU.

For each active finger 121, the system 100 can include an array of rich input metadata on which sophisticated touch interactions can be built, exceeding that of contemporary touchscreens. For example, in addition to identification of a touch event, the model estimates touch force during this step 205. 3D key-point data from the hand pose tracking phase also provides a wealth of information, including finger identification (thumb, index finger, etc.) and 3D finger angle.

Although process can work on a frame-by-frame basis, the system 100 derives touch-down and touch-up events to expose a conventional touch input state machine at step 206. This is how a vast majority of user interfaces are driven, and so it is useful to make the approach immediately compatible with existing software. The finger touch state machine also lets the system 100 trigger more specialized touch event handlers, such as onDrag and onLongClick that are available some operating systems. These specialized touch events are similar to click-and-drag or click-and-hold using a conventional computer mouse, enabling an expanded touch interface using the system 100.

Finally, at step 207, the output, which may include identification of a touch event, can be utilized in a user application. Many computer vision models require large and expensive desktop-grade GPUs, making them impossible to run locally on today's mobile devices such as an AR/VR headset 150. Here, the model is capable of running on mobile hardware as a background process. The system 100 can run the model at 90 FPS or more (i.e., max framerate of the image sensor 101 on current AR/VR headsets 150) and consume a small fraction of the mobile device's processing power.

To test the accuracy of the system 100, touches registered by the system 100 can be compared to touches registered by a ground truth sensor, such as a binary capacitive touch sensor affixed to the underside of a user's finger 121. Accuracy is tested across a range of conditions, including differing skin tones, hair densities, lighting conditions, indoor vs. outdoor locations, touch types, inputting finger 121, near hover vs. touch, and on-body touch location. Touch locations on appendages 122 include: inner forearm, inner palm, outer forearm, and back of the hand. At each of these locations, users performed four touch types during the test: momentary taps, long light presses, long hard presses, and finger hovers. Illumination levels ranged from 12 Lux outside at night with distant street lights to 35,000 Lux outdoors in full sun. Finally, users were not constrained in movement or to a particular environment during the test.

A total of 15 users used the system 100 to provide data for accuracy testing. For each participant, that participant's data is withheld for evaluation and combined the other 14 participants' data into a training set (all combinations with results combined; i.e., leave-one-participant-out cross-validation). Such a train-test scheme means there is no “calibration” or equivalent data in the training set, and it is if a general pre-trained model is seeing the user for the first time (i.e., “out-of-the-box” accuracy).

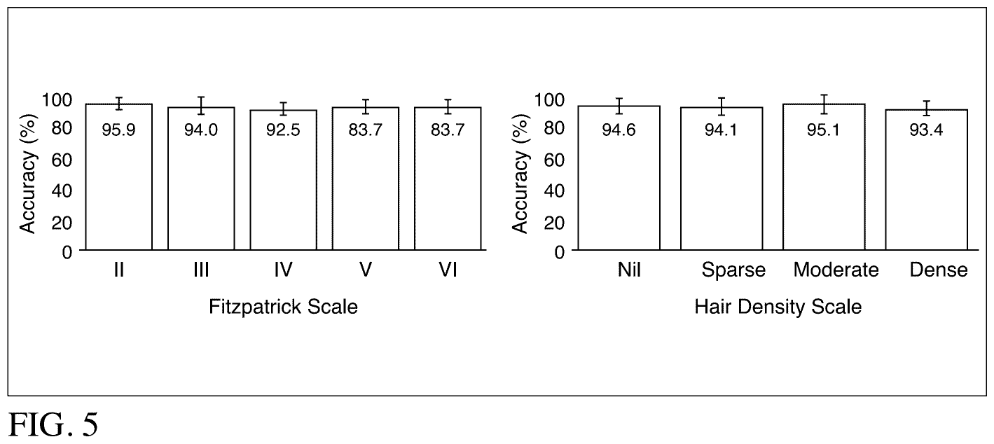

For a first test, a between-subject Bayesian factor analysis was conducted on all data (across 4 touch locations, 4 touch-types, and 2 location conditions) to investigate the likelihood of either skin tone or hair density affecting accuracy. As depicted in FIG. 5, the analysis showed moderate evidence (BF₁₀<0.33) that accuracy was not affected by these two factors. This is an encouraging result, as this can be a major issue in some human-sensing computer vision systems. Thus, results are reported across all participants in subsequent analyses.

To evaluate the system's touch classification accuracy, testing used 32 rounds of index finger data (across body input locations, touch types, lighting conditions, etc.) which contained 125,656 touching frames and 181,844 non-touching/hovering frames. The mean frame-wise classification accuracy was 94.9% (std=3.5). True positive touch detection rate was 96.4% and false positive rate was 5.6%.

Rather than consider accuracy on a frame-by-frame basis, testing can also look at event-wise “click” accuracy (i.e., touch-down and touch-up events). Across the 2783 touch events captured, the system 100 has a mean click event accuracy of 95.6% (std=8.3). Note: for an event frame to be considered correct, the predicted event and ground truth event had to occur in the exact same frame (at a capture rate of 30 FPS).

Also using index finger data, the system's force estimation accuracy is evaluated. Forces ranged from 0 N to 3.5 N (mean=1.1 N). Forces exerted on a typical touch screen are roughly 1 N. The system 100 estimated force with a mean absolute error of 6.8% (std=3.9) across all participants. Put simply, if a user applied a ground truth force of 1.0N, a 6.8% error would be ±0.068N of force. If the dataset is separated into two force ranges: (0, 1N) (soft and medium presses), and (1N, 3.5N) (hard presses), classification accuracy is 97.9%. Such touch metadata could be used to trigger functionality like that seen on mobile phones with advanced touch controls, such as iPhone models with “3D Touch”/“Force Touch”.

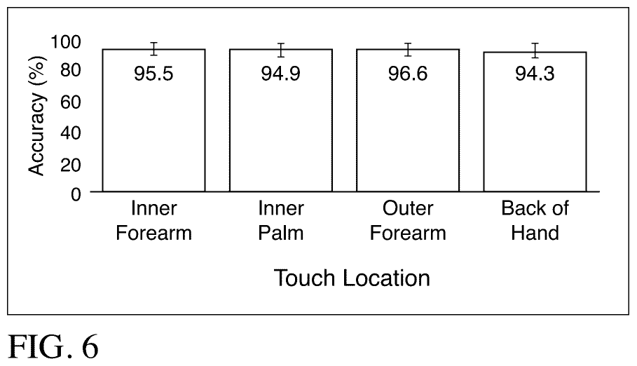

A Bayesian factor analysis can also be conducted to investigate the likelihood that Touch Location affected the accuracy of touch classification. The analysis of anecdotal evidence (BF₁₀<1) shows that the accuracy is not affected by the Touch Location (see FIG. 6). In particular, the outer forearm has anecdotal evidence to be higher than the inner-palm (BF₁₀=1.855) and the back of the hand (BF₁₀=3.225).

The accuracy test included indoor and outdoor data collection conditions, under both artificial and sun light, and even at night for two participants (example study frames provided in FIG. 8). The ambient illumination varied from 12 Lux (outside at night with distant metal-halide street lights), through 160 Lux (indoors in a dimly lit office using florescent tubes), all the way to 35,000 Lux (skin in direct sunlight). A Bayesian paired samples t-test did not suggest lighting condition impacted accuracy with anecdotal evidence. Mean touch classification accuracy was 94.7% (std=4.2) indoors and 95.7% (std=3.9) outdoors.

This result was somewhat unexpected, as low-light operation often is a weak spot for vision-based approaches. However, it seems the image sensor 101 was able to capture sufficient detail even at low light levels, and the noise and motion blur present in the image can be handled by the system 100. At the other end of the spectrum, in very bright conditions when there is little sensor 101 noise or motion blur (due to short image sensor 101 shutter speeds), the system 100 is sufficiently generalized to handle different shadow types, including harsh oblique shadows from direct light sources.

A Bayesian factor analysis was also conducted to investigate the likelihood that Touch Type affected performance. The analysis showed evidence (BF₁₀>3) that accuracy is affected by Touch Type. In particular, using post hoc comparisons, hard presses have better accuracy than light presses (BF₁₀=25.91). Taps and light presses showed equal performance (BF₁₀=0.85) as did taps and hard presses (BF₁₀=0.48).

Hard press events had the highest accuracy at 97.7% (std=4.5). This is not surprising as they produce the most exaggerated deformations of the user's skin. Light presses are harder to observe, especially on the back of the hand, which results in a decreased accuracy of 95.2% (std=11.6). It is noted that in light press trials, several participants remarked this was lighter than they would press on a conventional touch screen. Tap accuracy was slightly lower at 94.5% (std=15.4), likely due to the momentary nature of the interaction and motion blur from the rapid action.

Finally, data included events where participants hovered their finger 121 as close as they could above their skin. This condition was purposely included to assess robustness to close hovers, a challenge for prior depth-camera-driven touch systems. For these hovers, the system 100 was able to correctly detect hovers (i.e., that they were not touching) with an accuracy of 98.6% (std=1.9).

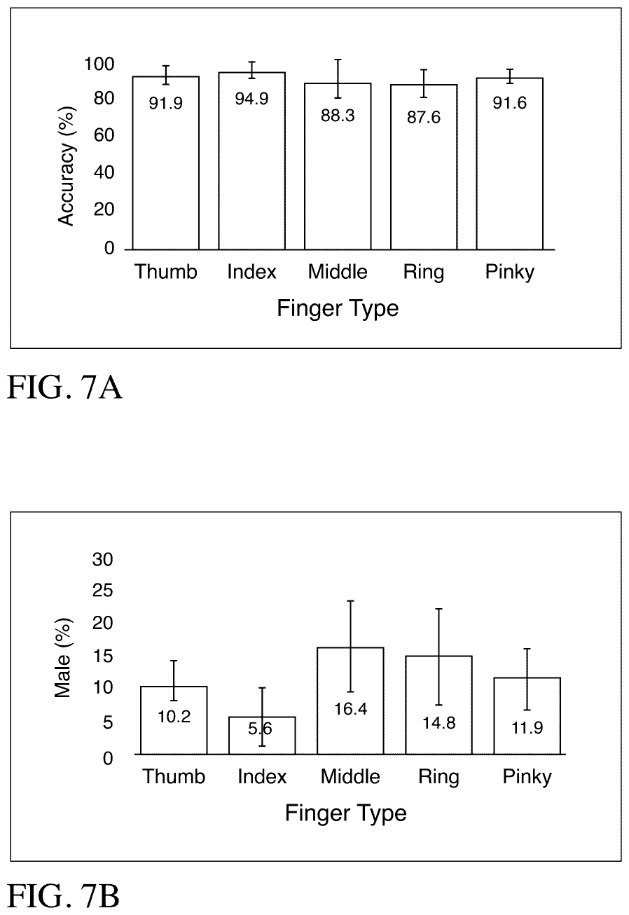

While accuracy testing focused on the use of the index finger 121 for input, data was also collected for each of the other four fingers 121. This means that each of the non-index fingers 121 makes up only about 2.8% (1 out of 36 rounds) of training data, and thus this result should only be considered preliminary. Overall, frame-wise touch classification accuracy was 91.9%, 88.3%, 87.6%, and 91.6% for the thumb, middle, ring, and pinky fingers 121, respectively (see FIG. 7A). For touch force estimation, frame-wise mean absolute error was 10.2%, 16.4%, 14.6%, and 11.3% for the thumb, middle, ring, and pinky fingers, respectively (see FIG. 7B).

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A method of identifying contact between a finger and an appendage of a user, the method comprising:
obtaining image data using an image sensor positioned near a head of the user, wherein the image sensor has a field-of-view of the appendage of the user; and
detecting whether the finger is contacting the appendage based on a change in appearance of a surface of the appendage resulting from contact with the finger.

2. The method of claim 1, further comprising:
determining whether the finger and the appendage of the user are present in the field-of-view of the image sensor.

3. The method of claim 2, further comprising:
returning a positive indication if the finger and the appendage are present and the finger is within a predetermined distance from the appendage.

4. The method of claim 1, wherein the image sensor obtains the image data without illuminating the finger or the appendage.

5. The method of claim 1, wherein the finger and the appendage are free from instrumentation.

6. The method of claim 1, further comprising:
detecting an active finger in the image data by determining a position of the finger relative to a wrist of the user.

7. The method of claim 1, further comprising:
normalizing the image data by rotating the finger in the image data to a uniform orientation.

8. The method of claim 1, further comprising:
constructing a finger patch from the image data to isolate an area centered at a tip of the finger.

9. The method of claim 1, further comprising:
running a vision transformer, wherein the vision transformer identifies contact between the finger and the appendage.

10. The method of claim 9, wherein the vision transformer provides at least one of touch force, finger identification, and three-dimensional finger angle.

11. The method of claim 1, further comprising:
inputting the image data into an event state machine to provide an output of ‘touch’ or ‘no touch’.

12. The method of claim 1, further comprising:
providing identification of a touch event to an end user application.

13. The method of claim 1, wherein the image sensor is a red/green/blue camera, infrared camera, or an ultraviolet camera.

14. The method of claim 1, wherein the image sensor is integrated into an augmented reality or virtual reality headset.

15. The method of claim 1, wherein the image sensor does not have a fixed field-of-view relative to the appendage.

16. A system for identifying contact between a user's finger and a surface of the user's skin comprising:
an image sensor adapted to be worn by a user, wherein the image sensor has a field-of-view encompassing at least one hand or arm of the user when worn by the user;
a processor for receiving image data from the image sensor, wherein the processor is adapted to identify a touch event based on the image data.
